(19) United States
(12) Patent Application Publication
(10) Pub. No.: US 2018/0054148 A1
(43) Pub. Date: Feb. 22, 2018

(54) METHOD AND SYSTEM FOR SENSORLESS CONTROL OF A PMSM MOTOR

(71) Applicant: Lakeview Innovation Ltd., Buochs (CH)

(72) Inventor: Chen Zhao, Thalwil (CH)

(21) Appl. No.: 15/682,225

(22) Filed: Aug. 21, 2017

(30) Foreign Application Priority Data
Aug. 22, 2016 (CH) 01079/16

(51) Int. Cl. H02P 21/32; H02P 21/24; H02P 6/182

(52) U.S. Cl. CPC H02P 21/32; H02P 21/24; H02P 6/185; H02P 2207/055; H02P 2203/11; H02P 6/182

(57) ABSTRACT

A method and system for adaptive sensorless determination of the position of a PMSM motor is described. The system and method include: determining the rotor position and the rotor polarity by means of discrete signal injection for the range between standstill up to low rotational speed; determining the rotor position by means of continuous signal injection at a rotational speed that is lower than a first changeover speed; determining the rotor position by means of back EMF at a rotational speed that is higher than the first changeover speed; wherein by means of a motor control system, depending on the rotational speed, a switch is made between rotor position determination by continuous signal injection and rotor position determination by back EMF; and wherein during movement of the rotor, the rotor polarity and/or the rotor position are/is monitored and optionally adjusted at a point in time using the rotor polarity and/or the rotor position at a previous point in time.

### CROSS REFERENCE TO RELATED APPLICATION

This application claims priority to Swiss Patent Application No. 01079/16, filed Aug. 22, 2016, the entire disclosure of which is hereby incorporated herein by reference.

### FIELD OF THE INVENTION

The present invention is directed to the field of controlling electronically commutated motors. The present invention relates to a method and a system for sensorless control of a permanent magnet synchronous machine (PMSM) motor.

### BACKGROUND OF THE INVENTION

PMSM motors are frequently used in applications, for example in the medical field, in which the dynamics of the motor play an important role. Reliable control of the motor requires precise knowledge of the rotor position, for which purpose position sensors, for example Hall sensors or optical sensors, are used in conventional applications. However, the use of sensors increases the costs and the complexity, such as for cabling and the motors, and has an adverse effect on the reliability and robustness of the drives.

For these reasons, various methods for sensorless control of PMSM motors have been developed in the recent years, which are divided primarily into two categories, and which have different advantages and disadvantages with regard to the motor type and/or the motor dynamics.

In the first category, the rotor position is determined by the rotating permanent magnet via the back electromotive force (EMF). The methods based on the back EMF have little or no suitability for standstill conditions and low speeds, since in these ranges the signal of the back EMF disappears or is too small to ensure an adequate signal-to-noise (S/N) ratio.

The second category includes methods that make use of anisotropy of the motor. Anisotropy may include, for example, magnetic saliency of the rotor or magnetic saturation effects in the iron core of the stator. These methods offer the advantage that a position determination is possible even for standstill conditions or at low speeds. However, these methods require sufficient inherent magnetic anisotropy so that an adequate signal-to-noise ratio can be achieved. The magnetic saliency (L_{q}>L_{d}) may be utilized for an asymmetrical rotor, for example in a PMSM motor having an embedded permanent magnet. In contrast, for a PMSM motor having surface-mounted permanent magnets, the anisotropy is too small (L_{q}≈L_{d}), so that saturation effects must generally be used. For ironless motors, saturation effects generally cannot be utilized.

When determining the rotor position based on the anisotropy of the motor, it is common to apply test signals, having a frequency that is significantly above the fundamental frequency of the motor, to the PMSM motor, which is generally referred to as signal injection. For signal injection, a distinction is typically made between periodically applied (discrete) test signals and continuously applied test signals.

One example of determining the rotor position by the injection of periodic, discrete test signals is the indirect flux detection by the on-line reactance measurement (INFORM) method, developed by M. Schroedl and described, for example, in ETEP, Vol. 1, No. 1, January/February 1991, pp. 47-53, and which is suitable for standstill conditions as well as low rotational speeds. In the INFORM method, the current increases of the phases are evaluated based on specific test voltage vectors in order to determine the complex stator inductance in the various space vector directions. The rotor position is then determined from the stator inductance. One drawback of this method is the high currents that occur when the voltage vectors are applied, which may result in distortions of the currents and accompanying oscillating torques.

The continuously applied test signals include, among others, rotating test signals and alternating test signals. For the rotating test signals, the high-frequency carrier signal is applied in the stator coordinate system as a rotating complex space vector that is superimposed on the fundamental oscillation. Information concerning the rotor position may be obtained from the phase-modulated response signal. For the alternating test signals, a high-frequency carrier signal is applied along the d or q axis of the expected rotor coordinate system, and a position-dependent response signal due to the error between the expected position and the instantaneous position of the rotor along the orthogonal axis is measured. The magnitude of the response signal is dependent on the machine anisotropy, which is generally unfavorable for surface-mounted PMSM motors.

The known methods for position determination from the prior art thus require certain properties of the motor, such as anisotropy, or a certain state, such as a minimum speed. If one of these properties or states is not present, the position determination generally cannot be carried out, or delivers unreliable results due to the poor signal-to-noise ratio.

### SUMMARY OF THE INVENTION

A method and a device for sensorless determination of the position of a PMSM motor is disclosed.

In one implementation, a method is disclosed for adaptive sensorless determination of the position of a PMSM motor, with the method comprising: a. determining the rotor position and the rotor polarity by means of discrete signal injection for the range of rotational speeds between standstill up to a predetermined rotational speed (e.g., a low rotational speed); b. determining the rotor position by means of continuous signal injection at a rotational speed that is lower than a first changeover speed; c. determining the rotor position by means of back EMF at a rotational speed that is higher than the first changeover speed; wherein by means of a motor control system, dependent on the rotational speed, a switch is made between rotor position determination by continuous signal injection and rotor position determination by back EMF; and wherein during movement of the rotor, the rotor polarity and/or the rotor position are/is monitored and adjusted at a point in time by using the rotor polarity and/or the rotor position at a previous point in time. Thus, the switching may be between: determining the rotor position using one of continuous signal injection at a rotational speed that is lower than a first changeover speed or back electromotive force (EMF) at a rotational speed that is higher than the first changeover speed; and thereafter determining the rotor position using another of the continuous signal injection at the rotational speed that is lower than the first changeover speed or the back EMF at the rotational speed that is higher than the first changeover speed. Thus, in one implementation, the method does not use a sensor at all in the determination of the position of a PMSM motor. In this regard, in a specific implementation, the method and the PMSM motor are sensor free and the determination of the position of a PMSM motor does not use any sensor.

In one implementation, sensorless position determination can be understood to mean the determination of the rotor angle as well as the determination of the rotor polarity. In an alternate implementation, sensorless position determination can be understood to mean one or both of: the determination of the rotor angle; or the determination of the rotor polarity.

In one implementation, the method provides reliable and flexible position determination for at least a part (such as the entire) rotational speed range of the PMSM motor due to the adaptive combination of the various methods for position determination. In particular, for operation of the PMSM motor from standstill to a very low speed, the method according to one implementation determines an accurate value of the rotor position and/or the rotor polarity by means of discrete signal injection, since in this phase the useful current and the current controller of the motor, among other factors, do not have to be activated. The rotor position and/or rotor polarity thus initially determined by the discrete signal injection may then be used for the position determination by continuous signal injection. If the deviation of the rotor polarity and/or the rotor position is below a certain correction threshold, an adjustment of zero (i.e., no correction) may be provided. Since the rotor position and/or the rotor polarity can initially be determined by the discrete signal injection, the entire pulse width modulation period is advantageously available for torque generation when the motor is started. The discrete signal injection may be discontinued as soon as the position determination by continuous signal injection begins. The first changeover speed, at which the position determination switches from continuous signal injection to determination by means of back EMF, is generally dependent on the type of motor, and may be set by the motor control system as a function of one or more motor characteristics. Example motor characteristics include, but are not limited to: the magnetic pole number; the winding geometry; the winding wire diameter; the winding resistance; or the magnet type.

In one implementation, a switch is made between the position determination by discrete signal injection and the position determination by continuous signal injection at a second changeover speed by use of the motor control system, wherein the discrete signal injection is used at standstill or at a rotational speed below the second changeover speed, and the continuous signal injection is used at a rotational speed above the second changeover speed. The second changeover speed may depend on the type of motor, or on motor characteristics.

Alternatively, the position determination by discrete signal injection is discontinued as soon as the rotor position and/or the rotor polarity are/is initially determined, and the position determination is continued using continuous signal injection.

In one implementation of the method, prior to the rotor position determination, a calibration step is performed in which a calibration curve of a parameter depending on the motor impedance is essentially independent of the rotor magnetic field, and is generated as a function of the angular position of the stator field, and in which a parameter curve determined during the position determination is compensated by the calibration curve.

The calibration step may be performed prior to the rotor position determination by discrete signal injection and/or prior to the rotor position determination by continuous signal injection. Forming a calibration curve that is essentially independent of the rotor magnetic field offers the advantage, among others, that the calibration curve may be used on measurement curves for any given rotor angle. In one implementation, the degree of the independence of the calibration curve from the rotor magnetic field may be understood to be within the tolerance range known by those skilled in the art. Since the calibration curve is formed by a parameter, which is dependent on the motor impedance, as a function of the angular position of the stator field, the motor impedance determined in the discrete and/or continuous signal injection can be calibrated or compensated for by the calibration curve as a function of the angular position of the stator field. As a result, values, such as offsets, that are essentially independent of the rotor magnetic field may be compensated for, which advantageously increases the signal-to-noise ratio of the position values measured by signal injection. The angular position may be an absolute angular position, or also a relative angular position.

In one implementation of the method, the calibration curve is stored in a memory, such as in a lookup table in a nonvolatile data memory of a motor control unit. One example of a nonvolatile data memory is a flash memory. Other types of nonvolatile data memory are contemplated.

The motor control units of the PMSM motors generally already have memory segments in which the calibration curve may be stored. It is thus advantageous that no additional units have to be added to the PMSM motor in order to store the calibration curve. The calibration curve stored in the nonvolatile data memory of the motor control unit may be read out from the data memory as needed.

In one implementation of the method, the measured values determined in the rotor position and/or rotor polarity determination by discrete signal injection and/or continuous signal injection are corrected by the data from the calibration step, wherein the difference is generated between the parameter curve and the calibration curve determined during the rotor position determination by discrete and/or continuous signal injection.

Since the calibration curve is essentially independent of the rotor magnetic field, the difference generation may basically be used to carry out filtering, in which the rotor magnetic field-independent components of the parameter curve determined during the discrete and/or continuous signal injection are filtered out. The difference curve resulting from the difference generation generally has the largest difference (between the determined parameter curve and the calibration curve) for a specific angular position, on the basis of which the rotor angle may be deduced. The difference generation provides the advantage that the signal-to-noise ratio may be increased. The rotor angle may thus also be determined in situations in which the signal-to-noise ratio is too low for the discrete and/or continuous signal injection alone, in order to enable a reliable position determination. The difference generation using the calibration curve may also be applied to the rotor polarity determination during the discrete signal injection.

In one implementation, a sample period is used in the rotor position determination by continuous signal injection, wherein a rotor position determination is carried out in each sample period, and the determined rotor position is compared to the rotor position from the preceding sample period and corrected if necessary.

The sample period is generally limited by the pulse width modulation frequency. The accuracy of the position determination may generally increase for longer sample periods at the same pulse width modulation frequency.

The length of the sample period may be selected in such a way that the rotor angle does not change by more than a predetermined angle (e.g., more than 90°) during the sample period.

Thus, the rotor polarity and rotor position from a preceding sample period (such as the directly preceding sample period) may be used for monitoring and/or correcting the rotor polarity.

The position determination may optionally be combined with an observer in order to shorten the sample period, which may allow for more rapid position determination.

In one implementation of the method, the first changeover speed is less than 5% of the nominal speed of the motor, such as between 0.1% and 3%, or such as between 0.2% and 3%, of the nominal speed of the motor.

In one implementation of the method, the frequency of the continuous signal injection essentially corresponds to the pulse width modulation frequency, or alternatively, to one-half the pulse width modulation frequency, of the motor control system.

The frequency of the continuous signal injection may be in a range of 50-200 kHz.

A PMSM motor is further disclosed for operation by the method disclosed. The PMSM motor comprises: a motor control system configured to switch between rotor position determination by discrete and/or continuous signal injection and/or rotor position determination by back EMF; a nonvolatile memory configured to store and read out rotor position and/or rotor polarity data, and/or calibration data for generating a calibration curve; and a processing unit configured to generate a difference between the measured parameter curve and the calibration curve.

In one implementation, the PMSM motor is calibrated by a method according to the present description.

In one implementation, the PMSM motor has an ironless winding. PMSM motors with ironless or unslotted windings have various advantages over windings with iron cores, such as no magnetic detent torque, high efficiency, low inductance, etc. However, due to the properties of these motors, alternative methods for controlling the motor are generally used. For example, with regard to the position determination, the anisotropy in these motors is low, and known methods based on saturation effects have little or no use. Methods for position determination by discrete and/or continuous signal injection, which are based on the anisotropy, therefore generally have a small signal-to-noise ratio for ironless or unslotted PMSM motors, so that reliable position determination is often not ensured. In particular, use of the calibration curve offers the advantage that the signal-to-noise ratio may also be increased in ironless PMSM motors in such a way that the rotor position and/or rotor polarity may be reliably determined.

In one implementation, the PMSM motor is an S-PMSM motor having surface-mounted permanent magnets.

For S-PMSM motors, due to the low anisotropy, the position determination based on anisotropy is generally not possible or involves great effort. In particular, the use of the calibration curve here allows for the signal-to-noise ratio to be increased even for S-PMSM motors, so that the rotor position and/or rotor polarity may be reliably determined.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements. The figures show the following:

FIG. 1 shows a schematic illustration of one exemplary implementation of the method;

FIG. 2 shows an illustration of a calibration curve and a measured parameter curve;

FIG. 3 shows an illustration of a difference curve; and

FIG. 4 shows a schematic illustration of a motor system according to an implementation.

### DETAILED DESCRIPTION OF EMBODIMENTS

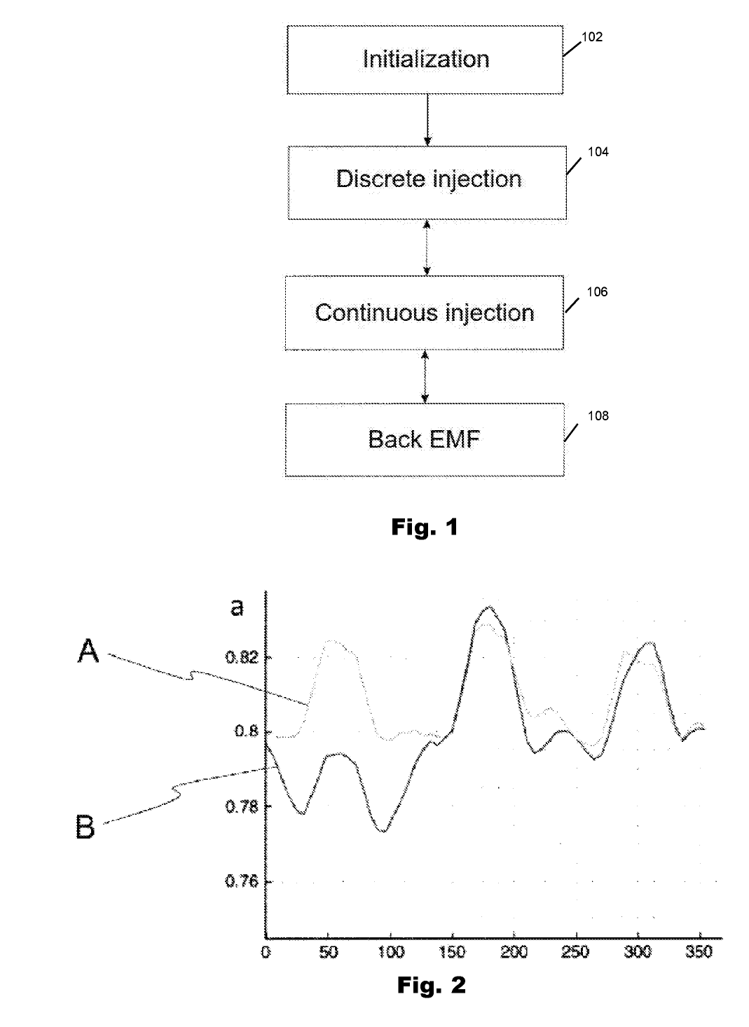

FIG. 1 shows a schematic illustration, in the form of a flow chart, of one exemplary implementation of the method according to the invention for determining the position of a PMSM motor. The system parameters are determined in a first initialization step at 102. In the exemplary implementation shown, the calibration curve is determined in the initialization step. The calibration curve is stored in a nonvolatile data memory of the motor or the motor control unit. When the motor is at a standstill, in a next step the initial rotor position and the initial rotor polarity are determined by discrete signal injection. This may be achieved by applying suitable test signals in various directions, for example using the INFORM method. At 104, the values determined by the discrete signal injection are processed, using the calibration curve stored in the nonvolatile data memory, and on this basis the rotor position and the rotor polarity are determined. The discrete signal injection may be used for standstill conditions and at very low rotational speeds, such as in a range of 0.1-1% of the nominal speed of the motor. If the initial rotor position and the rotor polarity are known, the discrete signal injection is discontinued and the position determination is carried out by continuous signal injection. At 106, the continuous signal injection may be carried out with a rotating space vector, for example. During the position determination, the instantaneous position is determined or adjusted, taking into account the position at the previous points in time. Sample periods may be introduced for this purpose, so that in a given sample period the position determination uses the values from the preceding sample period. The calibration curve may also be used for the continuous signal injection in order to process the values determined by the continuous signal injection, and based thereon determine the rotor position. In response to the rotational speed of the rotor reaches a first changeover speed (e.g., as soon as the rotational speed of the rotor reaches the first changeover speed), a switch is made to the position determination by back EMF at 108, wherein the first changeover speed is a rotational speed at which the signal of the back EMF is sufficient to ensure a signal-to-noise ratio that allows a reliable position determination. As indicated by the double arrows in FIG. 1 between 106 and 108, a switch may be made, for example as a function of the rotational speed, between the various position determination methods as required.

A calibration curve A is shown in FIG. 2. FIG. 2 also shows a measured parameter curve B. The parameter curve B may have been recorded, for example, during the discrete signal injection or during the continuous signal injection. The rotor position is unknown during measurement of the parameter curve B. Based on the two curves in FIG. 2, it is apparent that, in comparison to calibration curve A, parameter curve B shows a strong dependence on the rotor magnetic field between approximately 25° and approximately 95°.

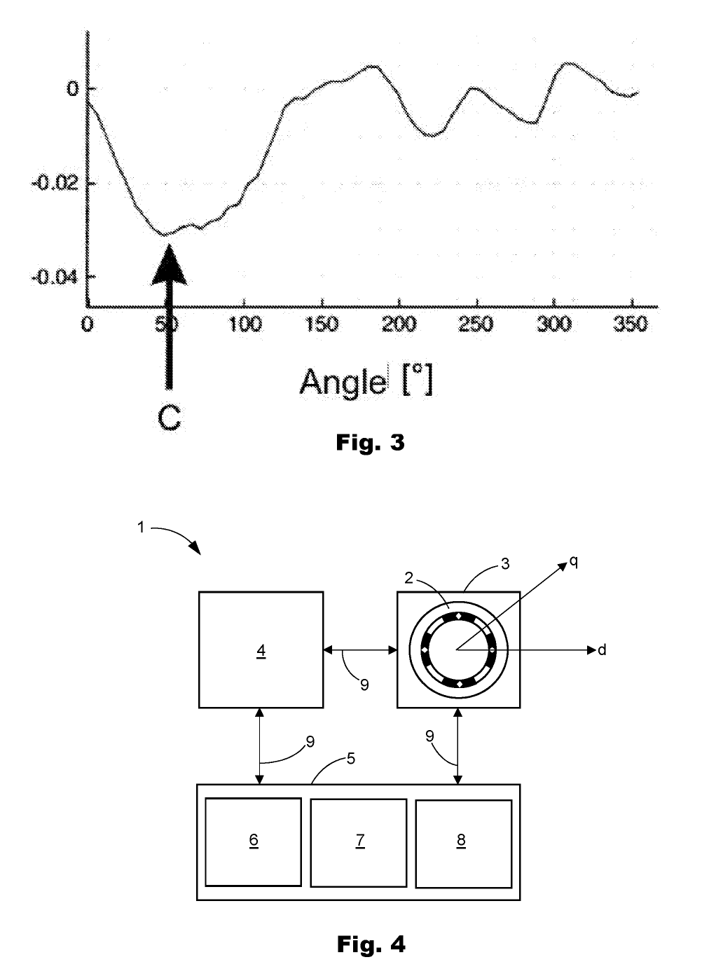

This is clarified by forming the difference d between the parameter curve B and the calibration curve A. The resulting difference curve is shown in FIG. 3. The dependence on the rotor magnetic field is greatest at an angle (see arrow C) at which the difference d is at a maximum. This angle is therefore the rotor angle, since the influence of the rotor magnetic field is strongest at this angle.

FIG. 4 shows a schematic illustration of a motor system 1 according to an implementation of the present invention. The motor system 1 is adapted for switching between rotor position determination by discrete and/or continuous signal injection and/or rotor position determination by back EMF for determining the orientation of a rotor 2 of an ironless PMSM motor 3 of the motor system 1. The motor system 1 further comprises a measuring device 4 and a control device 5. The measuring device 4 is adapted for measuring the current in the phases of the motor 3. The control device 5 comprises a processing unit 6 for digitally and/or analoguely generating a difference between the measured parameter curve and the calibration curve, a memory unit 7, such as a non-volatile memory, for storing and reading out rotor position and/or rotor polarity data, and/or calibration data for forming a calibration curve, and a switching unit 8 for digitally and/or analoguely switching between rotor position determination by discrete and/or continuous signal injection and/or rotor position determination by back EMF. FIG. 4 illustrates the separate elements of the processing unit 6, the memory unit 7, and the switching unit 8, with the processing unit 6 being in communication with memory unit 7 and switching unit 8. Alternatively, the functions performed by these units may be in a single element within control device 5.

The processing unit 6 is adapted for digitally and/or analoguely determining the position of the rotor 2 by discrete and/or continuous signal injection and/or rotor position determination by back EMF. The processing unit 6 may comprise a microprocessor or other type of processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. In particular, the processing unit 6 may be configured to perform the analysis (such as the calibration, determination, etc.) and the control aspects described herein. For example, the processing unit 6 may be in communication with memory unit 7 and switching unit 8. Further, the processing unit 6 may receive one or more inputs (such as one or more sensor inputs) in order to determine one or more aspects of the motor system 1 (e.g., the position of the rotor (such as by one or both of the discrete signal injection and continuous signal injection) and/or the rotor position determination (such as by back EMF). Further, the processing unit 6 may be configured to generate voltage pulses as well as discrete and continuous voltage signals to the phases of the motor 3. In addition, the processing unit 6 may be configured to generate one or more control signals as input to the switching unit 8, in order for the switching unit to switch between rotor position determination by discrete and/or continuous signal injection and/or rotor position determination by back EMF. In this regard, the processing unit 6 may comprise logic, such as computable executable instructions, which enable the determination of the one or more aspects of the motor system 1, the control of the motor, and the control of the switching unit 8.

Energy and/or data transmission lines 9 of the motor system 1 allow for transmitting electrical energy, data and/or measurement values between the motor 3, the measuring device 4 and the control device 5.

Thus, in a specific implementation, a method for adaptive sensorless determination of the position of a PMSM motor is disclosed. The method comprises: (a) determining the rotor position and the rotor polarity by means of discrete signal injection for the range between standstill up to low rotational speed; (b) determining the rotor position by means of continuous signal injection at a rotational speed that is lower than a first changeover speed; (c) determining the rotor position by means of back EMF at a rotational speed that is higher than the first changeover speed; wherein by means of a motor control system, dependent on the rotational speed, a switch is made between rotor position determination by continuous signal injection and rotor position determination by back EMF; and wherein during movement of the rotor, the rotor polarity and/or the rotor position are/is monitored and adjusted at a point in time by using the rotor polarity and/or the rotor position at a previous point in time.

Further, the method may be characterized in that prior to the rotor position determination, a calibration step is carried out in which a calibration curve of a parameter depending on the motor impedance is essentially independent of the rotor magnetic field, and is generated as a function of the angular position of the stator field, and in which a parameter curve determined during the position determination is compensated by the calibration curve. In addition, the method may be characterized in that the calibration curve is stored in a lookup table in a nonvolatile data memory, preferably a flash memory, of a motor control unit. Also, the method may be characterized in that the measured values determined in the rotor position and/or rotor polarity determination by discrete signal injection and/or continuous signal injection are corrected using the data from the calibration step, wherein the difference is generated between the parameter curve and the calibration curve determined during the rotor position determination by discrete and/or continuous signal injection.

In a further specific implementation, the method is characterized in that a sample period is used in the rotor position determination by continuous signal injection, wherein the rotor position determination is carried out in each sample period, and the determined rotor position is compared to the rotor position from the preceding sample period and corrected if necessary. Further, the method is characterized in that the length of the sample period is selected in such a way that the rotor angle does not change by more than 90° during the sample period. The first changeover speed may be less than 5%, preferably between 0.1% and 3%, particularly preferably between 0.2% and 3%, of the nominal speed of the motor. The frequency of the continuous signal injection may essentially correspond to the pulse width modulation frequency, or to one-half the pulse width modulation frequency, of the motor control system.

Likewise, a PMSM motor is disclosed that uses the method in the specific implementation. The PMSM motor comprises a motor control system for switching between rotor position determination by discrete and/or continuous signal injection and/or rotor position determination by back EMF; a nonvolatile memory for storing and reading out rotor position and/or rotor polarity data, and/or calibration data for forming a calibration curve; and a processing unit for generating a difference between the measured parameter curve and the calibration curve. The PMSM motor may be calibrated using a calibration step in which a calibration curve of a parameter depending on the motor impedance is essentially independent of the rotor magnetic field, and is generated as a function of the angular position of the stator field, and in which a parameter curve determined during the position determination is compensated by the calibration curve. As discussed above, the calibration curve is stored in a lookup table in a nonvolatile data memory, preferably a flash memory, of a motor control unit. Further, the measured values determined in the rotor position and/or rotor polarity determination by discrete signal injection and/or continuous signal injection may be corrected using the data from the calibration step, wherein the difference is generated between the parameter curve and the calibration curve determined during the rotor position determination by discrete and/or continuous signal injection.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

1. A method for adaptive sensorless determination of position of a permanent magnet synchronous machine (PMSM) motor, the method comprising:
determining rotor position and rotor polarity by discrete signal injection for a range between standstill up to a predetermined rotational speed;
switching, using a motor control unit and based on rotational speed, between:
determining the rotor position using one of continuous signal injection at a rotational speed that is lower than a first changeover speed or back electromotive force (EMF) at a rotational speed that is higher than the first changeover speed; and
thereafter determining the rotor position using another of the continuous signal injection at the rotational speed that is lower than the first changeover speed or the back EMF at the rotational speed that is higher than the first changeover speed.

2. The method of claim 1, wherein the rotor position is determined by the continuous signal injection at the rotational speed that is lower than the first changeover speed and thereafter by back EMF at the rotational speed that is higher than the first changeover speed.

3. The method of claim 1, wherein switching, based on rotational speed, between determinations of the rotor position is performed iteratively.

4. The method of claim 1, wherein controlling the at least one aspect of the motor based on the determined position comprises:
monitoring, during movement of the rotor, at least one of the rotor polarity or the rotor position; and
adjusting one or both of the rotor polarity or the rotor position at a point in time by using at least one of the rotor polarity or the rotor position.

5. The method of claim 1, further comprising, prior to determining the rotor position, performing a calibration step in which a calibration curve of a parameter depending on motor impedance is essentially independent of rotor magnetic field, and is generated as a function of angular position of a stator field of the motor, and in which a parameter curve determined during the position determination is compensated by the calibration curve.

6. The method of claim 5, wherein the calibration curve is stored in a lookup table in a nonvolatile data memory of the motor control unit.

7. The method of claim 5, wherein measured values determined in one or both of the rotor position and the rotor polarity, determined by one or both of the discrete signal injection and the continuous signal injection, are corrected using data from the calibration step; and
wherein a difference is generated between the parameter curve and the calibration curve determined during the rotor position determination by one or both of the discrete signal injection and the continuous signal injection.

8. The method of claim 1, wherein determining rotor position by the continuous signal injection uses a sample period;
wherein determining the rotor position is performed in each sample period; and
wherein the determined rotor position is compared to the rotor position from a preceding sample period and corrected if necessary.

9. The method of claim 8, wherein a length of the sample period is selected such that rotor angle does not change by more than 90° during the sample period.

10. The method of claim 1, wherein the first changeover speed is less than 5% of a nominal speed of the motor.

11. The method of claim 1, wherein the first changeover speed is between 0.1% and 3% of a nominal speed of the motor.

12. The method of claim 1, wherein the first changeover speed is between 0.2% and 3% of a nominal speed of the motor.

13. The method of claim 1, wherein frequency of the continuous signal injection essentially corresponds to pulse width modulation frequency of the motor control unit.

14. The method of claim 1, wherein frequency of the continuous signal injection essentially corresponds to one-half pulse width modulation frequency of the motor control system.

15. The method of one of the beforementioned claims, further comprising controlling at least one aspect of the motor based on the determined position.

16. A permanent magnet synchronous machine (PMSM) motor system comprising:
a motor; and
a motor control unit in communication with the motor, the motor control unit comprising a processor and a memory and configured to:
determine rotor position and rotor polarity by discrete signal injection for a range between standstill up to a predetermined rotational speed;
switch, based on rotational speed, between:
determining the rotor position using one of continuous signal injection at a rotational speed that is lower than a first changeover speed or back electromotive force (EMF) at a rotational speed that is higher than the first changeover speed; and
thereafter determining the rotor position using another of the continuous signal injection at the rotational speed that is lower than the first changeover speed or the back EMF at the rotational speed that is higher than the first changeover speed.

17. The PMSM motor system of claim 16, wherein the motor control unit is configured to switch between rotor position determination by one or both of the discrete signal injection and the continuous signal injection the rotor position determination by the back EMF; and
wherein the memory comprises a nonvolatile memory configured to store and read out one or both of the rotor position and rotor polarity data.

18. The PMSM motor system of claim 16, wherein the motor control unit is further configured, prior to determining the rotor position, perform a calibration step in which a calibration curve of a parameter depending on motor impedance is essentially independent of rotor magnetic field, and is generated as a function of angular position of a stator field of the motor, and in which a parameter curve determined during the position determination is compensated by the calibration curve.

19. The PMSM motor system of claim 18, wherein the memory comprises a nonvolatile memory;
wherein the nonvolatile memory is further configured to store calibration data for forming the calibration curve; and
wherein the motor control unit is further configured to generate a difference between a measured parameter curve and the calibration curve.

20. The PMSM motor of claim 16, wherein the motor has an ironless winding.

21. The PMSM motor of claim 16, wherein the motor is an S-PMSM motor having surface-mounted permanent magnets.

22. The PSMS motor system according to one of claims 16 to 21, wherein the motor control unit is further configured to control at least one aspect of the motor based on the determined position.
